(19) United States
(12) Patent Application Publication
(10) Pub. No.: US 2015/0362618 A1
(43) Pub. Date: Dec. 17, 2015

(54) Pulsed Neutron Measurement Method And System

(71) Applicant: Schlumberger Technology Corporation, Sugar Land, TX (US)

(72) Inventor: Peter Wraight, Skillman, NJ (US)

(21) Appl. No.: 14/303,295

(22) Filed: Jun. 12, 2014

(51) Int. Cl. G01V 5/10

(52) U.S. Cl. CPC G01V 5/102

(57) ABSTRACT

A method includes emitting a burst of neutrons having a first duration into earth formations. Neutrons are detected at a first position spaced apart from the emitting in two time intervals following the burst. After a selected delay time, a second duration neutron burst is emitted into the formations. Gamma rays are detected in selected time intervals following the second burst. The detected neutrons in the two time intervals are used to calculate a thermal neutron capture cross section. Gamma rays detected at the first position in following the second duration burst are used to determine an apparent formation thermal neutron capture cross section and to adjust a time interval for each of the first duration, the second duration and the starting time thereof for detecting gamma rays. The estimated wellbore thermal neutron capture cross section is used to determine an apparent formation thermal neutron capture cross section.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND

This disclosure is related to the field of pulsed neutron well logging instruments. More specifically, the disclosure relates to pulsed neutron well logging instruments having neutron burst and measurement timing controlled by measurements made by a detector in the instrument.

Pulsed neutron well logging instruments known in the art include instruments that have gamma ray detectors operated to detect gamma rays emitted as a result of thermal neutron capture (“capture gamma rays”) by selected elemental nuclei in subsurface formations having high neutron capture cross section. The most common of such chemical elements is chlorine, and measurements from such instruments are commonly used as a proxy for brine content in the formations. Brine content may be related to the fractional volume of pore space (porosity) in the formation and the fractional volume of the pore space that is occupied by brine (water saturation).

Measurements made by such instruments may be first used to calculate a parameter referred to as the thermal neutron decay time (tau). The value of tau calculated may then be converted to a value of the thermal neutron capture cross section (sigma) of the formation by the expression:

Σ=4550/τ

SPE paper no. 2252, Sep. 19, 1968, revised manuscript received Oct. 8, 1970 published by SPE International, Richardson, Tex. explains in detail the advantages of the “Complete Scale-Factor Method”, and explains many of the technical aspects of thermal neutron decay time well log measurements.

An “automatic tau loop” data acquisition technique, where the neutron burst duration and the detector acquisition timing gates (both starting time and duration) are all adjusted according to the thermal decay time of the formation, is fully described in U.S. Pat. No. 3,662,179 issued to Frentrop et al., and is defined as “the Complete Scale Factor Method.”

The “Dual Burst” data acquisition technique is fully described in U.S. Pat. No. 4,721,853 issued to Wraight. The dual burst data acquisition technique, as described in the foregoing patent, is used in a fixed timing instrument where the short burst duration is always about 20 microseconds and the long burst is about 150 microseconds.

### BRIEF DESCRIPTION OF THE DRAWINGS

FIG. 1 shows an example pulsed neutron well logging instrument.

FIG. 2 shows a schematic diagram of example electronics and how pulsed neutrons are generated and the decay rate measured.

FIG. 3 shows a schematic diagram of an example electronic circuit part of an instrument cartridge.

FIG. 4 shows an example of the overall system with a surface deployed recording and control unit.

FIG. 5 shows an example of a measurement made by the instrument of FIG. 1.

FIG. 6 shows an example of neutron burst timing and gamma ray detection timing gates for a near spaced gamma ray detector.

FIG. 7 shows an example of neutron burst timing and gamma ray detection timing gates for a far spaced gamma ray detector.

FIG. 8 shows a graph of a porosity indicator ratio with respect to porosity in limestone.

FIG. 9 shows a graph of the square of the ratio shown in FIG. 8.

FIG. 10 shows a graph of the porosity indicator with an endpoint calibrated to a dense shale (80 p.u.).

FIG. 11 shows a graph of the porosity indicator with respect to porosity in three different lithologies.

### DETAILED DESCRIPTION

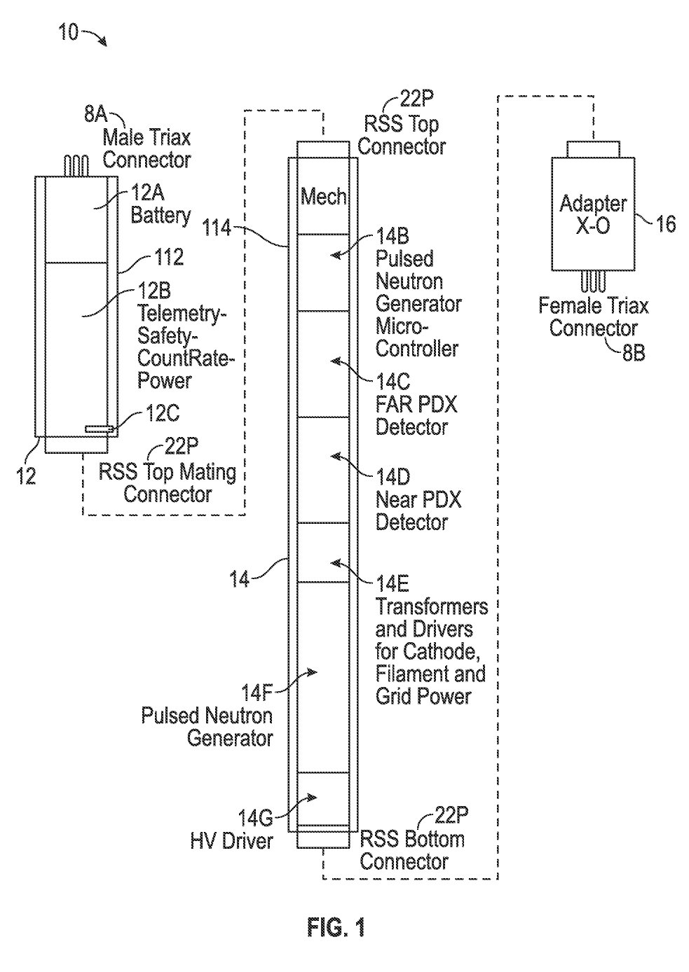

FIG. 1 shows an example embodiment of a pulsed neutron well logging instrument according to the present disclosure. The example instrument 10 may be made in three parts. The bottom part 16 may be a simple mechanical cross-over which is may be used to connect the instrument 10 to other well logging instruments disposed below the example pulsed neutron instrument 10. The two main parts are a cartridge 12 and a sonde 14. The cartridge 12 be disposed in a pressure resistant housing 112 configured to traverse a wellbore and may include therein circuitry 12B for communication with the surface, a power supply 12A, e.g., batteries for powering the sonde 14, circuits for controlling the safety of the sonde 14, especially control over operation of a pulsed neutron generator 14F and circuits (on board 12B) for processing data and counts from gamma ray detectors 14C, 14D in the sonde 14. The batteries 12A powering the system may be disposed inside the cartridge 12 as shown in FIG. 1. The cartridge 12 also may contain a pressure-operated switch 12C between the battery 12A and the electronic circuit board 12C. The switch 12C may be closed once a selected pressure (>100 psi) is applied to the instrument 10. Thus, at surface, the battery 12A is disconnected and it is not possible to generate neutrons.

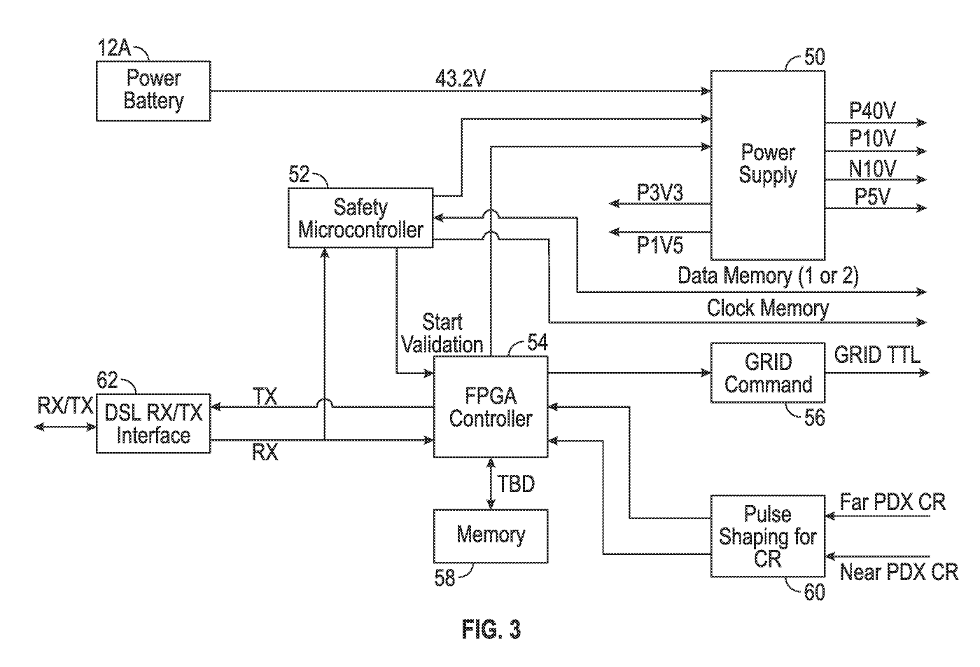

The sonde 14 may be disposed similarly in a pressure resistant housing 114 configured to traverse a wellbore and to couple to the cartridge housing 112. The sonde housing 114 may contain therein the pulsed neutron generator 14F (PNG), the high voltage power supply 14E for the PNG 14F, the gamma-ray detectors 14C, 14D and some electronic circuits 14G configured for driving the PNG 14F. The sonde 14 will be described in more detail with respect to FIG. 3. The PNG 14F may be any type known in the art, and in the present example may be a deuterium-tritium reaction accelerator type PNG that emits neutrons having initial energy of about 14 million electron volts (MeV). The gamma ray detectors 14C, 14D may be scintillation counters having a scintillation crystal of any known composition and a photomultiplier tube of any known configuration for use in wellbore instruments, although the type of gamma ray detector is not a limitation on the scope of the present disclosure.

The cartridge 12 may include any form of electrical/mechanical connector 8A at its upper end for coupling the cartridge 12 to a cable head or another instrument above the instrument 10 between the cable head (not shown) and the instrument. The sonde 14 may include an electrical/mechanical connector 8B at its lower end for coupling to another well logging instrument, or such connector 8B may be a termination or “bull plug” if no instruments are to be connected below the pulsed neutron well logging instrument 10.

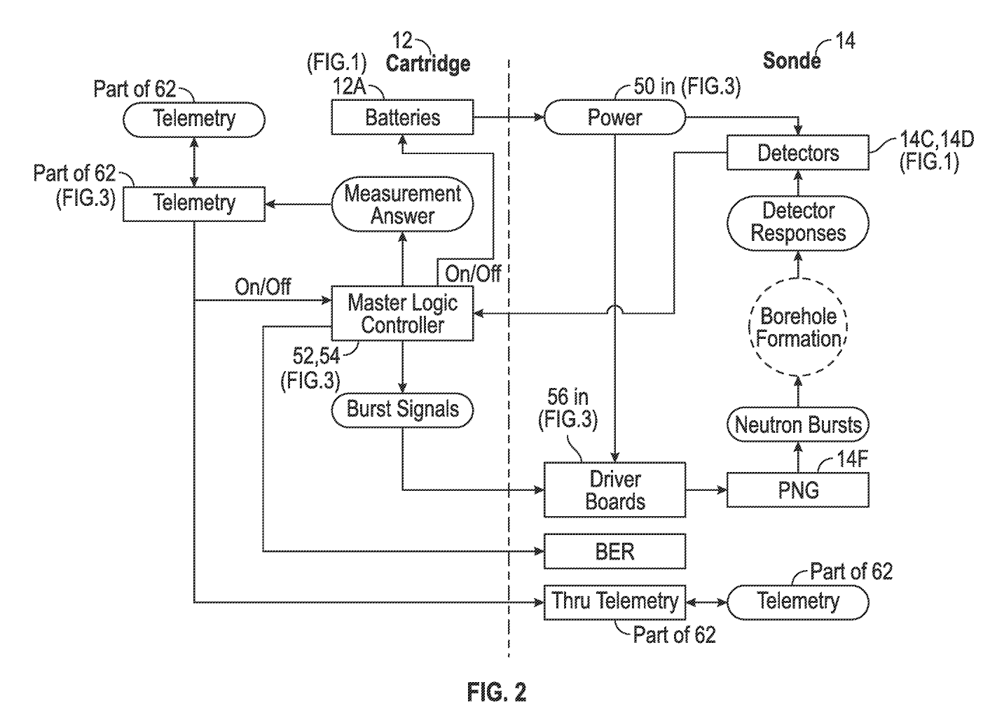

FIG. 2 shows a schematic diagram of example electronics and how pulsed neutrons are generated and the decay rate measured. An operating loop of the system may include: (i) the cartridge electronics (12B in FIG. 1) such as a master controller (also shown as 52 an 54 in FIG. 3) generates a burst signal that drives the PNG (14F in FIG. 1) through a driver board (e.g., 56 in FIG. 3) to generate neutrons; (ii) neutrons are generated and imparted into a formation surrounding a wellbore in which the instrument is disposed; (iii) neutrons react with the formation and gamma-rays (GR) are emitted; GR detectors (14C, 14D in FIG. 1) in the sonde measure those GR; (iv) data from GR detectors are received by the circuitry inside the cartridge (e.g., the master controller); and (v) depending on the numbers of gamma rays detected at various times during a cycle, a controller in the circuitry will shorten or enlarge the duration of the burst signal. A cycle may be repeated between every 500 microseconds and 4.55 milliseconds. The signals may be processed and some portion of the signals may be communicated by telemetry (62 in FIG. 3) to the surface. Commands and other data may be received from the surface, demodulated by the telemetry and communicated to the master controller. The present example is configured so that more than one well logging instrument may be included in a “string” of well logging instruments, and commands and other data may be communicated from the surface and data may be communicated to the surface through a common telemetry channel, but this is not a limitation on the scope of the present disclosure.

FIG. 3 shows a schematic diagram of the electronic circuit part of the cartridge. A safety microcontroller 52, which may be any form of microprocessor may be configured for communicating with the surface through a telemetry transceiver 62 and detecting and decoding command signals communicated from the surface. The safety microcontroller 52 may communicate with a field programmable gate array (FPGA) 54 to obtain gamma ray measurements (through pulse shaper 60) and other data from the sonde and to command the FPGA 54. The safety microcontroller 52 also controls a switching-on of power supplies 50 (that convert power from the batteries 12A) that is a safety aspect of the present example embodiment.

The FPGA 54 controls the above described measurement loop for the sonde (obtaining detector measurement data and setting the duration of the pulsed neutron burst). The FPGA 54 may receive specific commands from the surface for safety reasons. Thus both the FPGA 54 and the safety microcontroller 52 may be configured to detect a specific sequence to start operation of the PNG (14F in FIG. 1). Operation of the PNG is effected by sending commands to a grid controller 56 to apply a voltage pulse to an ionizer grid (not shown separately) in the PNG (14F in FIG. 1). Such operation control of a PNG is well known in the art. The power supply 50 may generate 3 DC voltages 5V, 10V and 40V using power supplied by the batteries (12A in FIG. 1). Data received by the safety controller 52 may be stored in a memory 58 such as a solid state memory or similar mass storage device.

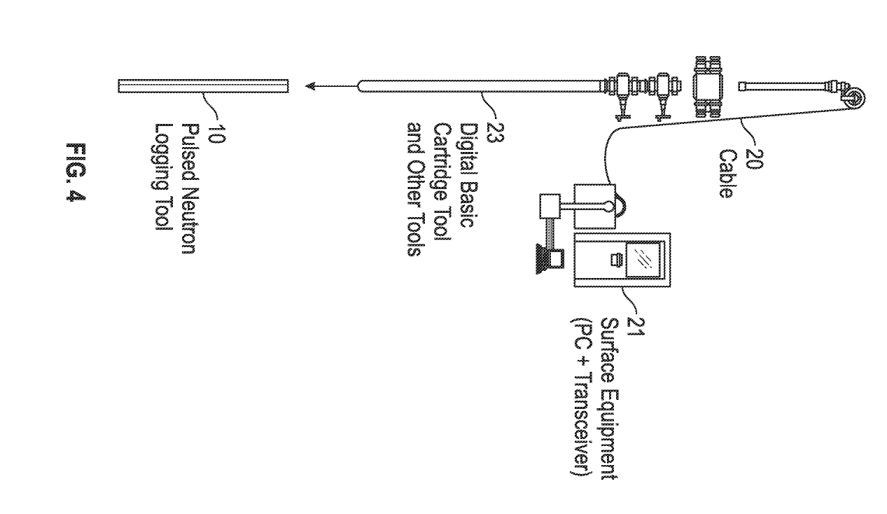

FIG. 4 shows an example of the overall system with a surface deployed recording and control unit 21, which may include a general purpose, programmable computer, electric slickline or armored electrical cable 20 to convey the instrument 10 and the instrument connected to the end of the slickline or cable 20. A telemetry or other type of interface system, shown generally at 23, may be included in some embodiments if there are further instruments connected to the cable 20 below the instrument 10. A non-limiting example of an electric slickline is described in U.S. Pat. No. 5,495,755 issued to Moore. It should be understood that the particular conveyance used in any example is not a limitation on the scope of the present disclosure.

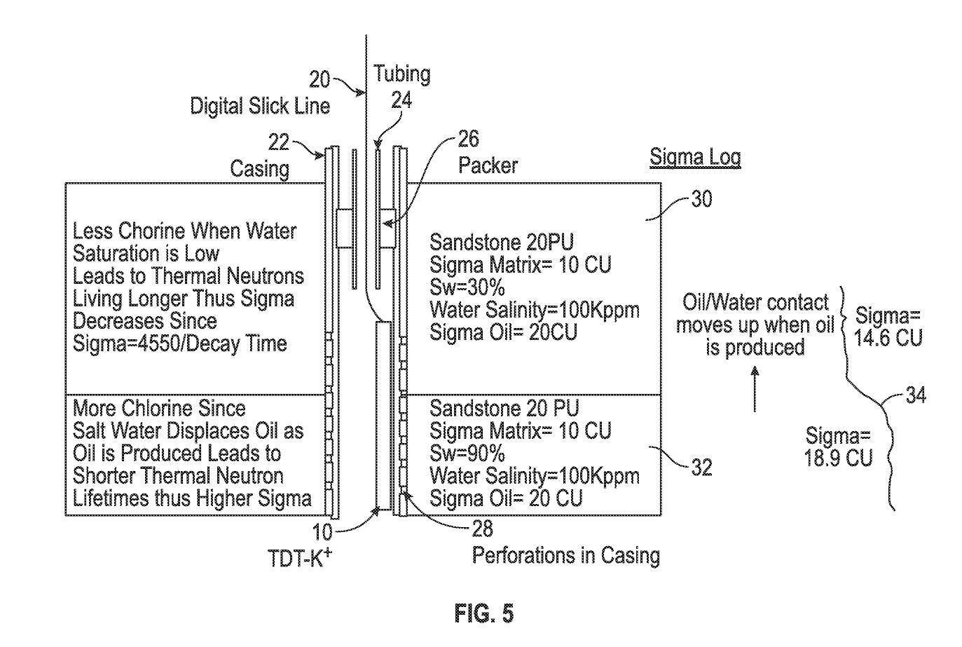

FIG. 5 shows a measurement made by the instrument 10, i.e., the detection of a boundary between 1 hydrocarbon bearing section 30 of a formation and a water baring section 32 of the formation. Since a pulsed neutron well logging instrument according to the present disclosure uses adaptive timing, where the neutron burst duration tracks the apparent thermal neutron decay time of the formation, the apparent formation sigma measurement may be largely insensitive to the borehole environment. The instrument may therefore be used with only a small amount of response characterization and still provide a clear measurement of the oil water contact.

In FIG. 5, the instrument 10 is moved along the interior of a casing 22 cemented in place in the wellbore. The casing 22 may have a smaller diameter conduit called a “tubing” or “velocity string” 24 disposed therein and sealingly engaged to the casing 22 using a packer 26 or similar annular sealing device. In the present example, the instrument 10 maybe conveyed by electric slickline 20. The casing 22 may include perforations 28 adjacent the formation from which hydrocarbons are to be extracted through the wellbore. Curve 34 provides an example of a calculated formation sigma measurement that shows an abrupt change in value at the boundary between the hydrocarbon bearing section 30 and the water bearing section 32 of the formation.

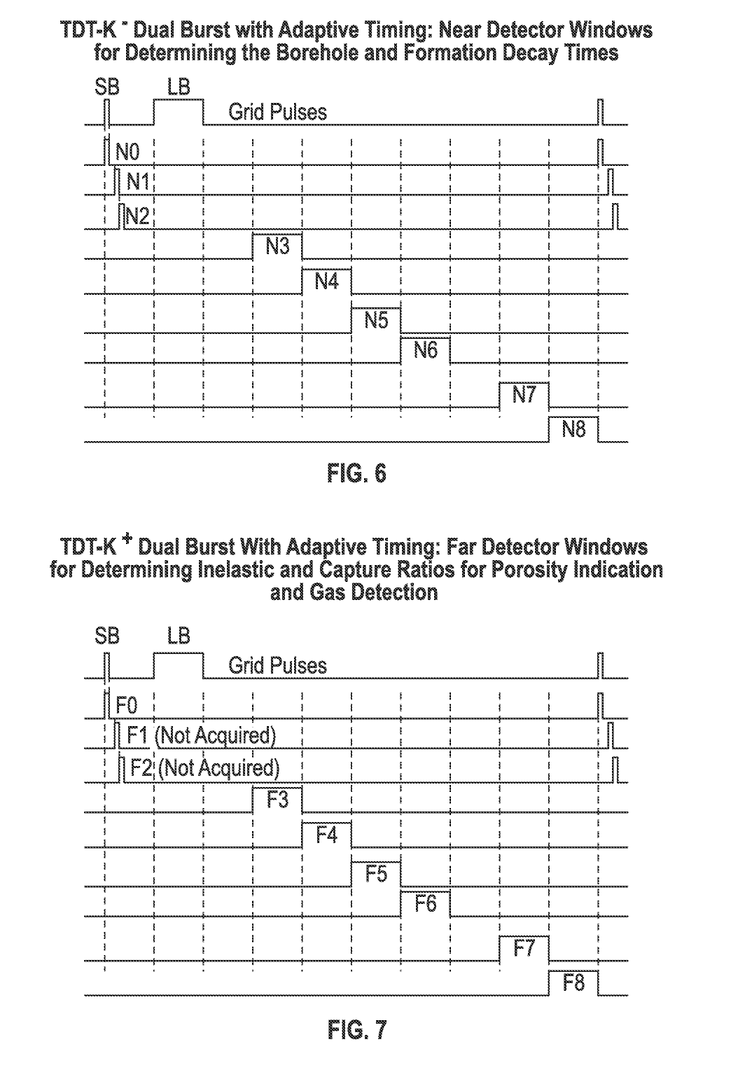

FIG. 6 shows an example of neutron burst timing and gamma ray detection timing gates for the near gamma ray detector (shown as 14D in FIG. 1). Collectively, the neutron burst times and gamma ray detection times comprise a measurement cycle. The duration of the entire cycle in the present example may correspond to ten Apparent Formation Tau Downhole loop (AFTDL) times. A long neutron burst LB (i.e., an operation of the PNG) may be 1 AFTDL long and a short burst SB may be 0.1 AFTDL long. Near detector counts may be acquired in nine time windows (N0 through N8) as shown. The first time window N0 is for gamma ray detections occurring during the short burst SB. Since the capture background is at a minimum at this time, the N0 count rate has a high proportion of inelastic gamma rays. The N0 count rate may be combined with the far detector count rate occurring during the same time window (F0 in FIG. 7) to enable calculation of an inelastic count rate ratio, which can be used as an Apparent Gas Indicator or “AGI.”

Counts detected in gates N1 and N2 are acquired starting after a delay of 0.1 AFTDL delay following the end of the short burst SB and are used to determine an Apparent Borehole Tau (ABT). A long duration neutron burst LB may begin at a time of 1 AFTDL after the beginning of the short bursts. The duration of the long burst LB may be equal to 1 AFTDL. Counting gate N3 may start after a time delay of 1 AFTDL following the end of the long neutron burst LB. Counting gate N3 may have a duration equal to the duration of the long burst LB and may be followed by contiguous detection timing gates N4, N5, N6 each having a duration equal to the duration of the long burst LB. There may then be time delay of 1 AFTDL, after which contiguous counting gates N7 and N8 may occur. At the time at which gate N7 begins, the thermal neutron capture count rate may have decreased to essentially zero and during gates N7 and N8 a long term activation count rate that builds in the near detector may be measured. The gamma ray detection measurements made in gates N7 and N8 may be referred to as the “background” radiation measurement.

FIG. 7 shows corresponding neutron burst (SB, LB) and the acquisition timing gates (F0, F3 through F8) for the far gamma ray detector (shown as 16C in FIG. 1). F0 counts gamma rays detected during the short burst (SB) and has a high proportion of inelastic counts, as explained with reference to N0 in FIG. 6. Since the far detector measurement may not be used in the calculation of borehole tau, the timing gates F1 and F2 may be omitted from the measurement sequence Counting gate F3 starts after a delay time of 1 AFTDL following the end of the long neutron burst LB. F3 may be followed by contiguous counting gates F4, F5, F6, each having a duration of 1 AFTDL. There may then be a delay of 1 AFTDL before contiguous counting gates F7 and F8 occur. As is the case for gates N7 and N8 explained with reference to FIG. 6, by the time N7 starts, the thermal neutron capture count rate has decreased to essentially zero and the F7 and F8 counting gates are a measurement of the long term activation count rate that builds in the far detector. The duration of the time gates F3, F4, F5, F6, F7, F8 may each be 1 AFTDL as explained above.

The downhole tau loop, which regulates the overall neutron burst timing and detection counting gate timing may be controlled by counting rate data from the near detector, in a manner very similar to that described in U.S. Pat. No. 3,662,179. However, because the background is only collected for 2 AFTDL times rather than 3 AFTDL times, as described in the foregoing patent, the count rate equation that needs to be balanced becomes:

4*(N5+N6)−2*N4−3*(N7+N8)=0

The controller adjusts the duration of the neutron burst timing until the above equation condition is met. The overall measurement cycle lasts 10 AFTDL times, the long neutron burst LB may be 1 AFTDL and the measurement counting gates are either 0.1 AFTDL or 1 AFTDL in duration, as explained above.

The downhole tau loop, which in the present disclosure may be called “Adaptive Timing” provides an Apparent Formation Tau (AFTDL) which is quite accurate and precise, but an improved result may be obtained by calculating an “Apparent Formation Tau Calculated” (AFTC) from the near detector timing gates (N3+N4), (N5+N6) and (N7+N8). By using the counts from gate N3 the statistical precision of the measurement may be improved and the rate at which AFTC may change is not limited by the downhole tau loop regulation time. Even if the downhole loop (or Adaptive Timing) is not exactly locked in to the changing Apparent Formation Tau, the AFTC will be correct.

The following operations may be performed on the counts in specific counting gates in order to determine AFTC.

The Adaptive Timing loop operation may be programmed into the controller and may balance the equation

4*(N5+N6)−2*N4−3*(N7+N8)=0

In one example counts in the foregoing gates transmitted to the surface may be averaged over a 1 second sample period. So the following count rates may be transmitted to the surface:

N0, N1, N2, N3, N4, (N5+N6), (N7+N8)

F0, F3, F4, (F5+F6), (F7+F8)

(N5+N6), (N7+N8), (F5+F6) and (F7+F8) may be transmitted to the surface using the telemetry as sums because the individual count rates in the foregoing individual gates are not needed and by combining them saves bandwidth in the telemetry.

First, all the count rates may be expressed as instantaneous count rates before the dead time correction, i.e.,

N0′=100*N0

N1′=100*N1

N2′=100*N2

N3′=10*N3

N4′=10*N4

(N5+N6)′=5*(N5+N6)

(N7+N8)′=5*(N7+N8)

F0′≦100*F0

F3′=10*F3

F4′=10*F4

(F5+F6)′=5*(F5+F6)

(F7+F8)′=5*(F7+F8)

Next, the counts in each of the time windows may be corrected for detector dead time:

N0″=N0′(1−N0′*K)

where in the present example, K is the dead time per pulse and in the present example K=0.000001. Other methods for correcting detector counts for dead time are known in the art.

N1″=N1′/(1−N1′*K)

N2″=N2′/(1−N2′*K)

N3″=N3′/(1−N3′*K)

N4″=N4′/(1−N4′*K)

(N5+N6)″=(N5+N6)′/(1−(N5+N6)′*K)

(N7+N8)″=(N7+N8)′/(1−(N7+N8)′*K)

F0″=F0′/(1−F0′*K)

F3″=F3′/(1−F3′*K)

F4″=F4′/(1−F4′*K)

(F5+F6)″=(F5+F6)′/(1−(F5+F6)′*K)

(F7+F8)″=(F7+F8)′/(1−(F7+F8)′*K)

The result is a set of instantaneous, dead time corrected count rates.

One may then perform a background subtraction on all the count rates in gates other than N7, N8, F7, F8. The background may be averaged over a selected time interval, in the present example at least 21 seconds to smooth the background count rate before subtraction. First the average background may be calculated from the counting rates in gates N7 and N8, and F7 and F8 to subtract from all the windows:

BKG_{—}N=(Σᵢ₋ₙⁱ⁺ⁿ(N7+N8)″)/(2n+1)

BKG_{—}F=(Σᵢ₋ₙⁱ⁺ⁿ(F7+F8)″)/(2n+1)

wherein n represents the number of acquisition cycles. If n=10 then the background will be averaged over 10 acquisition intervals of 1 second before the i-th level and 10 intervals after, i.e., it is a balanced 21 second filter. Now the background subtraction may be performed for all the counting gates other than the background gates (N7, N8, F7, F8).

N0′″(i)=N0″(i)−((BKG_{—}N)/2)

N1′″(i)=N1″(i)−((BKG_{—}N)/2)

N2′″(i)=N2″(i)−((BKG_{—}N)/2)

N3′″(i)=N3″(i)−((BKG_{—}N)/2)

N4′″(i)=N4″(i)−((BKG_{—}N)/2)

The reason why the background count rate is divided by 2 for the foregoing measurement gates is because the BKG_N is calculated over two gate times (N7+N8). The background counts during one gate time interval is thus half of that.

(N5+N6)′″(i)=(N5+N6)″(i)−BKG_{—}N

No division by two is needed for the foregoing gate measurement because there are two timing gates in the represented value. Similarly for the fare detector (14C in FIG. 1):

F0′″(i)=F0″(i)−((BKG_{—}F)/2)

F3′″(i)=F3″(i)−((BKG_{—}F)/2)

F4′″(i)=F4″(i)−((BKG_{—}F)/2)

(F5+F6)′″(i)=(F5+F6)″(i)−BKG_{—}F

It is then possible to calculate the outputs at each i-th level. First one may generate an output corresponding to the Apparent Formation Sigma derived from the Downhole tau Loop (AFSDL), and this is 4550/AFTDL. For example, if the tau time of the i th measurement is 180 microseconds then AFSDL=4550/180 which equals 25.28 capture units. This output may be used as a quality control indicator.

Next, determine the Apparent Formation Tau Calculated from the transmitted, dead time corrected count rates:

$$AFTC ( i ) = \frac{2 * AFTDL ( i )}{ln ( N {3}^{′′′} ( i ) + N {4}^{′′′} ( i ) ) - ln ( {( N 5 + N 6 )}^{′′′} ( i ) )}$$

Next determine an Apparent Formation Sigma Calculated (AFSC)(i), 4550/AFTC(i). The output of AFSC may be averaged over 5 seconds for presentation on a well log:

AFSC(log output)=(Σᵢ₋ₙⁱ⁺ⁿAFSC(i))/(2n+1), where n=2

At this time one may also average over 21 levels the count rates N1′″ and N2′″. These averaged count rates may be used to calculate an Apparent Borehole Tau Calculated (ABTC) and they need to be averaged before taking logarithms. Also average AFTC over the same 21 levels.

N1′″(averaged)=(Σᵢ₋ₙⁱ⁺ⁿN1′″)/(2n+1), where n=10

N2′″(averaged)=(Σᵢ₋ₙⁱ⁺ⁿN2′″)/(2n+1, where n=10

AFTC(averaged)=(Σᵢ₋ₙⁱ⁺ⁿAFTC)/(2n+1), where n=10

Next calculate the averaged ABTC from the following equation:

$$ABTC ( average ) = \frac{( AFTC ( average ) / 10 )}{ln N {1}^{′′′} ( average ) - ln N {2}^{′′′} ( averaged )}$$

Next calculate an apparent borehole sigma value:

$$Apparent Borehole Sigma Calculated ( ABSC ) ( averaged ) = 4550 / ABTC ( averaged )$$

The output to be displayed on a well log for the foregoing parameter will be ABSC(averaged). Next one may calculate a porosity indicator ratio:

RatPor(i)=(N3′″(i)+N4′″(i)+(N5+N6)′″)(i)/(F3′″(i)+F4′″(i)+(F5+F6)′″(i))

Log Output of RatPor=(Σᵢ₋ₙⁱ⁺ⁿRatPor(i))/(2n+1) where n=2

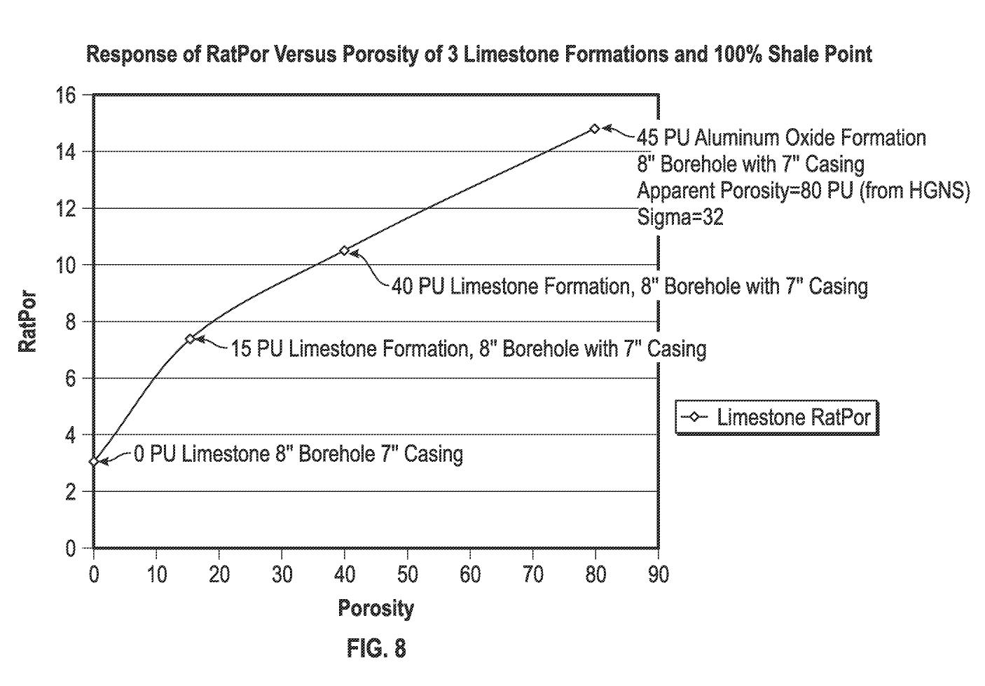

It may be observed how RatPor varies with limestone porosity by examining the graph in FIG. 8. The output in the present example embodiment may be an Apparent Porosity Indicator; it may not output a true formation porosity corrected for the borehole environment and the different lithologies of the formation. The “End Point” of the porosity transform is not the 100% water point but rather a 100% dense shale point. In an actual wellbore logging environment the highest neutron attenuating condition will be in high density shales. Large, water filled caverns are not encountered under normal logging conditions. By making the “end point” a high density shale, the Apparent Porosity Indicator transform will then be monotonic and stable over the entire range from low porosities, found in tight, clean, formations, to very high apparent porosities found in “gumbo” shales. The apparent porosity of the dense shale end point may be defined by what a standard “open hole” neutron porosity well logging instrument measures in such particular formation, which in this case is 80 PU.

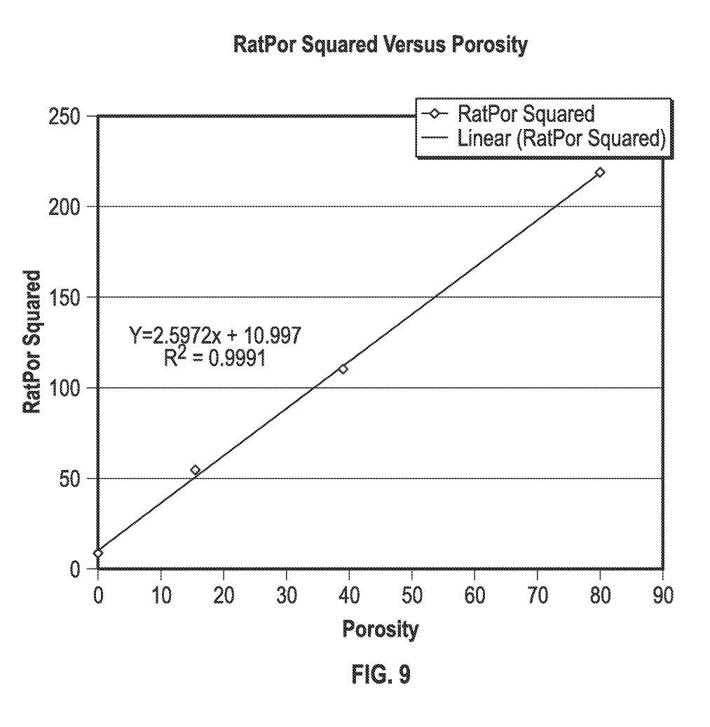

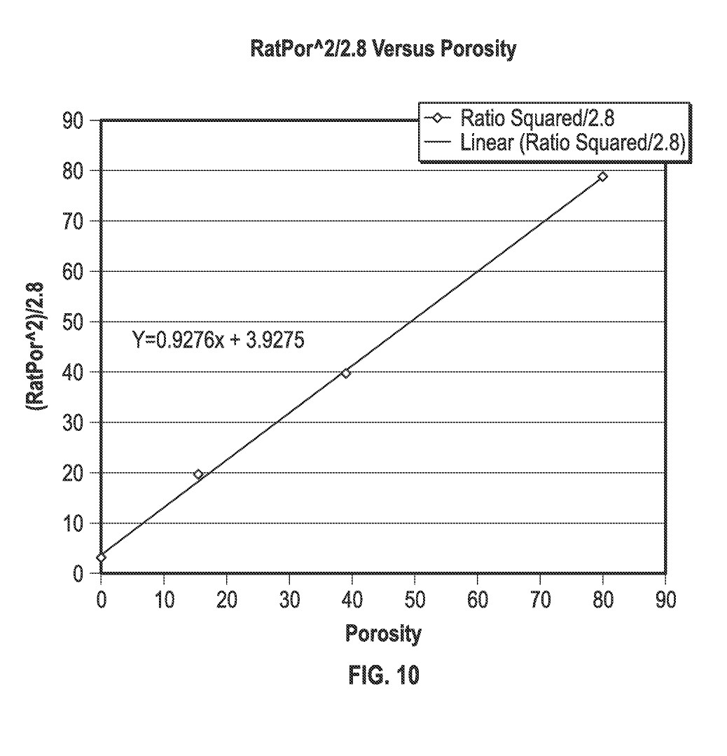

As can be observed in FIG. 8, RatPor does not vary linearly with porosity. However, the square of RatPor does vary substantially linearly with porosity, as may be observed in FIG. 9. To have an Apparent Porosity Indicator which not only varies approximately linearly with porosity but is also of approximately the correct magnitude one may use the output RatPor̂2/2.8 as shown in FIG. 10, therefore:

Log Output of Apparent Porosity Indicator=Log Output of RatPor̂2/2.8

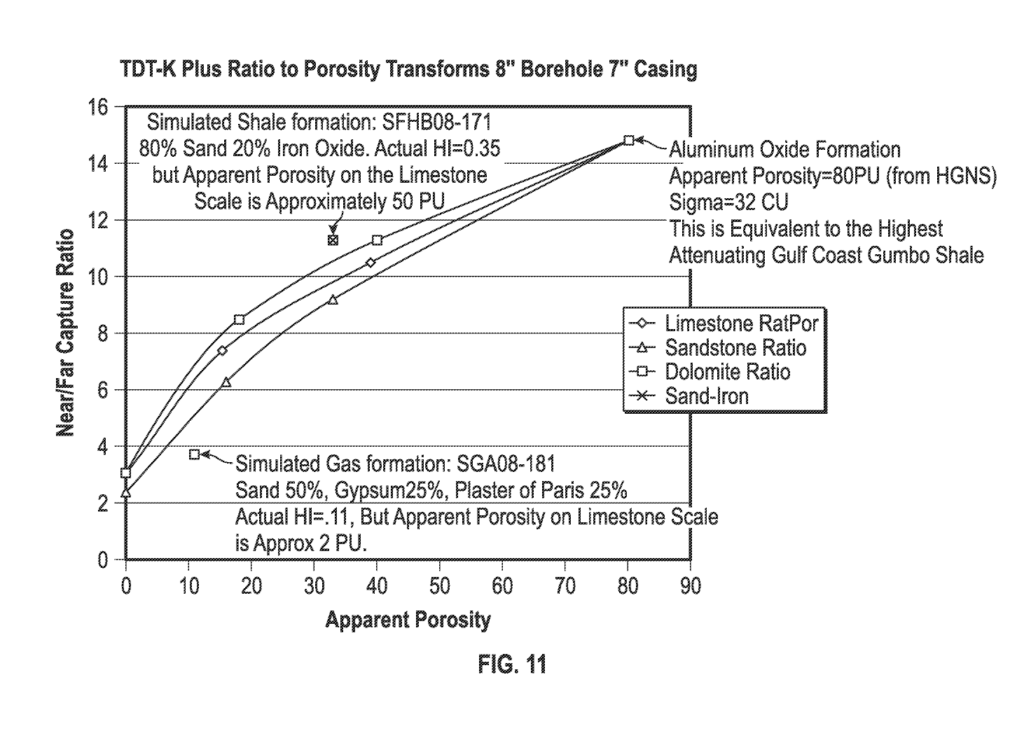

The foregoing output may be an adequate indicator of varying porosity that can be calibrated in situ with a known open hole porosity value (e.g., from a well log) if such data are available. A very significant amount of response characterization and Monte Carlo modeling would be needed to have a characterized porosity response. To show the response of RatPor in limestone, sandstone and dolomite, in and 8 inch diameter wellbore having therein a 20 pound weight per foot length, 7 inch external diameter casing, one may observe such results in FIG. 11.

Next one may use the inelastic count rate ratio (IRAT) as an Apparent Gas Indicator. The inelastic ratio may be calculated as:

IRAT=N0′″/F0′″

IRAT may be displayed as a raw on a scale of 0 to 20 entitled, “Apparent Gas Indicator.” There may be an indicator on the log (e.g., a darkened or other coded scale line) at a value of 10 and an indicator that shows an Apparent gas Indicator value of less than 10 there is a high probability of gas being present either in the borehole or the surrounding formation. As IRAT moves higher than 10 there is a decreasing probability that there is gas present.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for well logging, comprising:
emitting a first burst of high energy neutrons having a first duration into formations surrounding a wellbore;
detecting neutrons at a first position spaced apart from a position of the emitting in at least two time intervals following the first burst;
after a first selected delay time, emitting a second burst of neutrons having a second duration into the formations;
detecting capture gamma rays in selected time intervals at a first position spaced apart from the position of emitting neutrons in selected time intervals following the end of the second burst;
using the detected neutrons in the at least two time intervals after the first burst to estimate a value of thermal neutron capture cross section in the wellbore;
using the numbers of gamma rays detected at the first position in the selected time intervals following the second burst to adjust a time interval for each of the first duration, the second duration and the starting time and duration of the selected time intervals for detecting gamma rays at the first position and using the estimated wellbore thermal neutron capture cross section to determine an apparent formation thermal neutron capture cross section.

2. The method of claim 1 further comprising detecting inelastic gamma rays at the first position in during the burst having the first duration, detecting inelastic gamma rays at a second position further spaced from the position of emitting during the burst having the first duration and using a ratio of the detected inelastic gamma rays at the first and the second positions to indicate presence or absence of gas in the wellbore and/or formation.

3. The method of claim 1 further comprising detecting capture gamma rays at a second position farther from the position of emitting than the first position during the burst having the second duration during time intervals coincident with the selected time intervals, calculating a ratio of detected gamma rays at the first position with respect to the second position and using the ratio as an indication of porosity of the formations surrounding the wellbore.

4. The method of claim 4 further comprising correcting the numbers of detected gamma rays at the first and second positions for detector dead time.

5. The method of claim 4 further comprising subtracting background gamma ray counts detected after a thermal neutron population has decreased substantially to zero from the detected gamma ray counts detected before the thermal neutron population has decreased substantially to zero.

6. The method of claim 5 wherein measurements of background gamma ray counts are averaged over a selected time or depth interval prior to subtraction from the detected gamma rays counts made after the thermal neutron population has decreased substantially to zero.

7. The method of claim 6 wherein the averaging is performed over a depth interval of 21 depth measurements increments.

8. The method of claim 1 further comprising inhibiting emission of the burst of neutrons until a well logging instrument is disposed in the wellbore such that a predetermined fluid pressure exists externally to the well logging instrument.

9. The method of claim 1 further comprising inhibiting emission of the burst of neutrons until a selected control signal is communicated from the surface to a well logging instrument disposed in the wellbore.

10. The method of claim 1 wherein the using the counting rates measured after the second duration burst comprises calculating a difference between a value related to counting rates in a first selected time interval nearer in time to the second duration burst and a value related to counting rates in a second selected time interval farther in time from the second duration burst.

11. A well logging apparatus, comprising:
a pulsed neutron generator;
a controller in signal communication with the pulsed neutron generator;
a first gamma ray detector disposed at a first position spaced apart from the pulsed neutron generator and in signal communication with the controller; and
a second gamma ray detector disposed at a second position further spaced apart from the pulsed neutron generator than the first position, the second gamma ray detector in signal communication with the controller, the controller, the first and second gamma ray detectors disposed in a housing configured to traverse a wellbore;
wherein the controller is programmed to execute the following actions;
causing the pulsed neutron generator to emit a first duration burst of neutrons into formations surrounding a wellbore,
causing the first detector to detect neutrons in at least two time intervals following the first duration burst,
after a first selected delay time, causing the pulsed neutron generator to emit a burst of neutrons having a second duration into the formations,
causing the first detector to detect capture gamma rays in selected time intervals in selected time intervals following the end of the burst having the second duration,
using the detected neutrons in the at least two time intervals to estimate a value of thermal neutron capture cross section in the wellbore,
using the numbers of gamma rays detected at the first position in the selected time intervals following the second burst to adjust a time interval for each of the first duration, the second duration and the starting time and duration of the selected time intervals for detecting gamma rays at the first position and using the estimated wellbore thermal neutron capture cross section to determine an apparent formation thermal neutron capture cross section.

12. The apparatus of claim 11 wherein the controller is programmed to cause the first detector to detect inelastic gamma rays during the burst having the first duration, and causing the second detector to detect inelastic gamma rays at a second position further spaced from the position of emitting during the burst having the first duration and using a ratio of the detected inelastic gamma rays from the first and second detector calculate an indicator of presence or absence of gas in the wellbore and/or formation.

13. The apparatus of claim 11 wherein the controller is programmed to cause the second detector to detect capture gamma rays during time intervals coincident with the selected time intervals, to calculate a ratio of detected gamma rays detected by the first and second detector and to calculate a ratio of the detected gamma rays from the first and second detectors as an indication of porosity of the formations surrounding the wellbore.

14. The apparatus of claim 13 wherein the controller is programmed to correct the numbers of detected gamma rays by the first and second detectors for detector dead time.

15. The apparatus of claim 14 wherein the controller is programmed to subtract background gamma ray counts detected after a thermal neutron population has decreased substantially to zero from the detected gamma ray counts detected before the thermal neutron population has decreased substantially to zero.

16. The apparatus of claim 15 wherein the controller is programmed to average measurements of background gamma ray counts measured over a selected time or depth interval prior to subtraction from the detected gamma rays counts made after the thermal neutron population has decreased substantially to zero.

17. The apparatus of claim 16 wherein the controller is programmed to perform the averaging over a depth interval of 21 depth measurements increments.

18. The apparatus of claim 11 further comprising a pressure switch disposed in the housing and electrically coupled between a power supply and the controller to inhibit operation of the apparatus until a well logging instrument is disposed in the wellbore such that a predetermined fluid pressure exists externally to the well logging instrument.

19. The apparatus of claim 11 wherein the controller is programmed to inhibit operation of the pulsed neutron generator until a selected control signal is communicated from the surface to the controller.
